(19) United States
(12) Patent Application Publication
(10) Pub. No.: US 2003/0188649 A1
(43) Pub. Date: Oct. 9, 2003

(54) Flexible printing plate

(75) Inventor: William E. Hounshell, Amelia, OH (US)

Correspondence Address: WOOD, HERRON & EVANS, LLP, 2700 CAREW TOWER, 441 VINE STREET, CINCINNATI, OH, 45202, US

(73) Assignee: Phototype Engraving Company, Cincinnati, OH

(21) Appl. No.: 10/118,886

(22) Filed: Apr. 9, 2002

(51) Int. Cl. B41N 1/00

(52) U.S. Cl. 101/395

(57) ABSTRACT

Printing plate and method includes a printing member adhesively attached to a nonmetallic base suited for placement directly onto a printing cylinder.

### FIELD OF THE INVENTION

The present invention relates generally to printing, and more particularly, to printing plates and methods used in conjunction with the reproduction of images.

### BACKGROUND OF THE INVENTION

The versatility of flexographic printing processes has given rise to growing application in conjunction with paper, corrugated paperboard and plastic materials. In use, a flexographic plate is conventionally attached to a rotatable printing drum configured to transfer ink onto a substrate using a simple stamping application. Specific examples of items printed with flexography include: newspapers, milk cartons, frozen food and bread bags, as well as bottle labels.

Flexography typically utilizes a photopolymer plate having projections and other contours on a printing member with a surface that corresponds to a halftone screen and/or solid pattern. A halftone screen refers to a pattern of dots configured to create an image of varying tones and a solid pattern refers to areas having one consistent shade. A dot and/or solid pattern comprising the image can be output to film for conversion into a printing plate.

More particularly, a film containing the image is positioned over a photopolymer surface during plate manufacture. Ultraviolet light shines onto portions of the photopolymer surface exposed by the imaged area. The exposed portions form bonds, or chemical cross-links, in response to the ultraviolet energy. During subsequent washing processes, the unlinked portions of the photopolymer surface are removed from the surface, leaving behind those portions corresponding to the imaged area. As such, the resulting surface exhibits contours correlated to the halftone screen and/or solid patterns.

The printing member is conventionally fastened to one or more layers comprising a backing in order to form a composite plate. The backing, in turn, attaches to the printing cylinder or a drum attachment, such as a saddle. For example, some applications call for the plate to be glued or taped directly to the cylinder. In instances where the cylinder is magnetized, the backing will incorporate or completely consist of metal for the purpose of magnetically bonding the plate to the cylinder. As such, steel sheet backings are commonplace within the printing industry. Other backings are formed by mixing a ferrous metal powder within a volume of vinyl plastisol. As such, another layer of plastisol is cast on top of the base layer within a diaphragm mold. An oven heats, cures and fuses the layers directly together, taking care to avoid entrapped air and discontinuous bonding.

Still another known plate and associated backing combination calls for attaching a printing plate to a magnetic rubber backing. The plate and backing are separated by a thin layer of acetate that acts to protect the rubber surface. The composite printing plate subsequently clamps onto a saddle attachment using alignment pins. The saddle remains secured to the printing drum during operation.

While such methods of plate manufacture and attachment have effectively broadened the application of flexographic processes, such plate configurations nonetheless present accuracy, efficiency and manufacturing concerns of their own. For instance, complications in attaching the plate to the cylinder can present obstacles to printing processes. Namely, because the plates are primarily constructed in such a manner as to avoid slippage when the drum is in operation, less regard is paid to the removal of the plates. Consequently, the attaching glue or magnetic forces holding a metal backing to the drum can require substantial strength and effort when removal or repositioning on the cylinder is required.

Conventional backings are further prone to kinking and buckling that can frustrate a printing operation. For instance, a metal backing may suffer a crease or other deformity in the course of a manufacturing, installation or removal processes. Evidence of such a deformity can be transferred to the printing surface and ultimately compromise a printing operation. Costs to repair or reconstruct such plates drain manpower and other resources that could otherwise be spent more effectively. Morever, manufacturing and procurement costs associated with molding, pressing and heating processes required to fuse rubber backings to printing members can prove impractical and preclusive. Furthermore, saddle attachments to drums used in connection with certain printing configurations are often cumbersome and impractical.

Consequently, what is needed is an improved printing plate and method for using the same.

### SUMMARY OF THE INVENTION

This invention includes an improved printing plate and associated processes that addresses the shortcomings associated with the prior art as discussed above. Namely, the printing plate includes a printing member adhesively attached to a nonmetallic base. As such, an adhesive layer results between the printing member and the nonmetallic base. The nonmetallic base may incorporate ferrous particles useful in positioning the composite plate onto a magnetized printing cylinder. Such cylinders are presently utilized within the printing and die cutting industries. Of note, the nonmetallic base may incorporate magnetic particles to attract a weakly or non-magnetized printing cylinder as an alternative, or in addition to the ferrous particles.

The printing member preferably comprises a photopolymer, however, the invention is not limited to such surfaces and is compatible with all conventional printing and coating surfaces. As such, suitable printing members may be constructed from polymer, monomer, rubber, metal, and/or laminate material. The printing member preferably adheres directly to the nonmetallic base. As with the printing member, the material employed to laminate the printing member to the base may be varied to create various printing properties and is not limited to tape, glue, epoxy and/or adhesive foam.

Similarly, thicknesses associated with the various layers of the composite plate may vary to realize different printing textures and other effects. Morever, while the flexible, nonmetallic base may have particular application in areas of flexographic printing, the principles of the invention additionally apply to gravure, offset and photolithography, among others.

Significantly, the nonmetallic base promotes greater registration accuracy and repeatability. Properties of the nonmetallic base further facilitate ease of removal and repositioning of the printing plate with regard to the printing cylinder. Significantly, the nonmetallic base and associated techniques for attachment and printing reduce kinking and buckling effects plaguing current flexographic processes. Morever, the adhesive feature of the new system reduces manufacturing costs and preparation. For instance, one embodiment enables utilization of commercially available rubber sheeting and obviates requirements for molds and heating processes.

By virtue of the foregoing there is thus provided an improved printing plate and associated processes that address above identified shortcomings of known printing plates and associated techniques. The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 shows a block diagram that illustrates a halftone printing system that is consistent with the principles of the present invention;

FIG. 2 shows a cross-sectional view of a printing plate in accordance with the principles of the present invention and suited for use within the printing system of FIG. 1; and

FIG. 3 shows the printing plate of FIG. 2 disposed around a rotatable printing cylinder.

### DETAILED DESCRIPTION OF SPECIFIC EMBODIMENTS

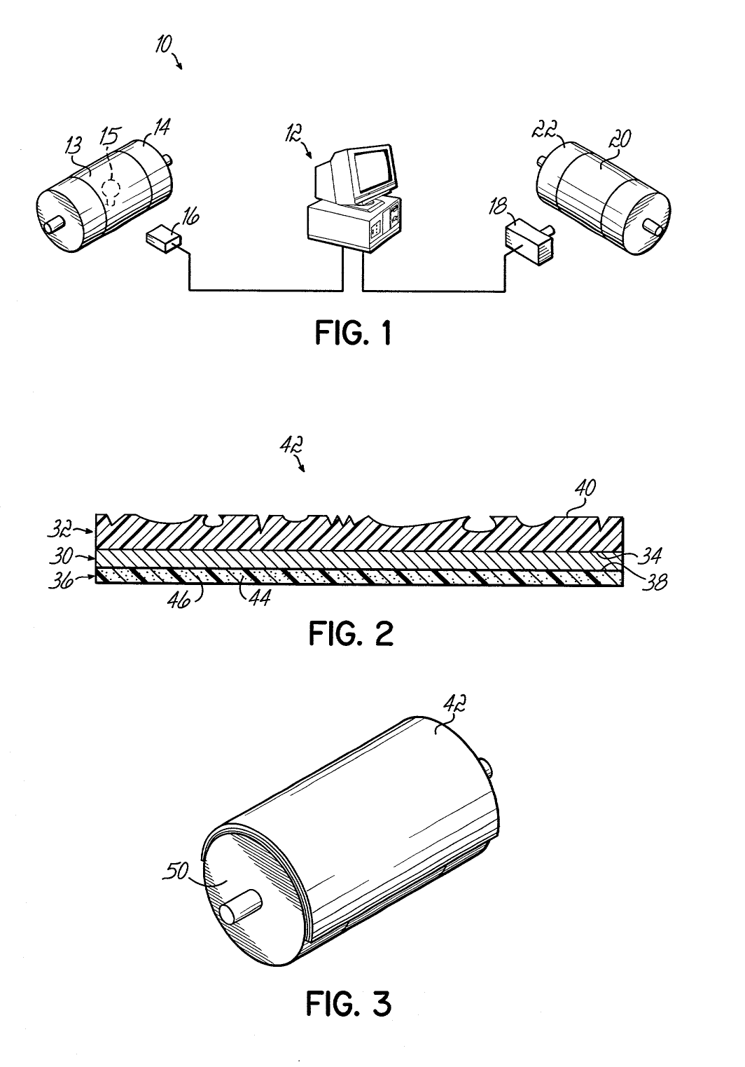

FIG. 1 conceptually illustrates the structure of a halftone screen and/or solid image production apparatus 10 consistent with the principles of the present invention. The apparatus 10 may use a raster image processor (RIP) 12 to manipulate image data scanned from a reading drum 14. A spot function executed by the RIP 12 can produce halftone screens configured to reproduce the image data.

Turning more particularly to FIG. 1, an original image 13 mounts onto the reading drum 14. A scanning head 16 successively records a signal embodying the image 13 as the reading drum 14 rotates at a predetermined speed. A light source 15, such as a halogen lamp, mounts within the reading drum 14. The light source 15 may pass light through the image 12 and into the scanning head 16. The system can relate image data recorded by the scanning head 16 to the RIP 12 in the form of raster and resolution independent vector path files.

The results of the evaluation determine whether an image setter will assign a black spot to an addressable point that corresponds to the coordinates. In this manner, the algorithm can group points to form a dot pattern comprising a screen. Thus, the RIP 12 transmits a dithered, binary file to the image setter 18 for producing a corresponding halftone screen. As discussed herein, a halftone screen can embody a pattern of dots configured to create an image of varying tones and/or colors. As such, the dots collectively convey an overall impression of the desired image.

An electronic gun of the image setter 18 exposes or sensitizes portions of a recording medium 20. The recording medium 20, which can include photosensitive paper, film or plates, mounts onto a rotatable recording cylinder 22. Of note, known software and hardware mechanisms may synchronize the rotation of the reading and recording drums 14, 22. A developer can then further process the recording medium 20 to create halftone screens.

As discussed herein, such a halftone screen may mask portions of a photopolymer surface in order to ultimately create a printing surface. Namely, ultraviolet light cross-links polymers exposed by the halftone screen. Unlinked portions of the photopolymer surface are washed from the surface, leaving only the bonded portion corresponding to the halftone screen. The resulting printing surface exhibits contours drawn to the halftone screen and the desired image.

As shown in the composite plate 42 of FIG. 2, a layer 30 of adhesive adheres to a nonprinting surface 34 a printing member 32. Of note, while suitable adhesives may include: glue, tape, porous adhesive, epoxy, laminate, adhesive foam and any combination thereof, others may be substituted as dictated by budgetary and other considerations particular to an application while still remaining in accordance with the principles of the present invention. Morever, as the consistency, hardness and resilient properties of adhesives can differ dramatically, various laminating techniques and product adhesives/adhesive combinations may be employed on an application specific basis to realize a desired printing effect.

For example, the adhesive layer 30 of an embodiment may incorporate foam properties. As such, the adhesive layer 30 may comprise adhesive tape featuring porous, resilient and/or foam characteristics. Such a feature may provide cushioning or other performance characteristics that facilitate desirable printing textures and coverage. Morever, another embodiment may call for a discontinuous adhesive layer 30. Such may be the case where strips of adhesive tape and/or applications of laminate do not completely blanket the nonprinting surface 34. The thickness of the adhesive layer 30 preferably ranges from about 0.005 inches to about 0.04 inches, but it should be understood that deviation from this range is contemplated as needed and would not be inconsistent with the principles of the invention. That is, a substantially thicker or thinner adhesive layer does not interfere with the printing member being adhered directly to the nonmetallic base 36.

As discussed herein, member 32 may comprise any number of surface materials suited for printing or otherwise transferring a coating substance onto a substrate. For instance, a preferred embodiment calls for a printing member 32 that comprises a photopolymer layer produced according to the techniques discussed above. It should be appreciated, however, that any rubber, plastic, metal or wood-derived material, among others, may be substituted as dictated by a particular application in accordance with the underlying principles of the invention.

An exemplary thickness of a suitable printing member 32 may range from about 0.03 inches to about 0.7 inches, but as above, this range may be expanded to accommodate different printing techniques and requirements.

For example, a conforming nonprinting surface 34 may include a coating, such as Mylar, to provide structure and stability to an image embodied within the printing member 32. The Mylar may additionally provide a uniform layer 34 and texture ideally suited for adhesive bonding.

In accordance with the plate 42 shown in FIG. 2, a top surface 38 of a nonmetallic base 36 attaches directly to the adhesive layer 30. The nonmetallic base 36 may comprise a rubber, polymer, mesh and/or webbed material 44 and preferably includes ferrous particles 46 dispersed throughout. In a scenario where a magnetized printing drum is utilized, the ferrous particles 46 act to hold the composite flexible plate 42 to a magnetic cylinder 50, as shown in FIG. 3. Such cylinders 50 are commonly utilized within the printing and die cutting industries. Of note, the quantity of ferrous particles 46 may be optimized to ensure necessary hold during printing operation, while still accommodating ease of plate 42 removal and repositioning.

Furthermore, the nonmetallic base 36 may incorporate magnetic particles to attract a weakly or non-magnetized printing cylinder 50 as an alternative or in addition to the ferrous particles 46. An exemplary thickness for the nonmetallic base 36 preferably ranges from about 0.01 inches to about 0.05 inches. However, this range may be expanded as desired to achieve varying printing textures, attractive forces and coverages.

As shown in FIG. 3, the nonmetallic base 36 attaches directly to the magnetic cylinder 50. Once the plate 42 is positioned on the cylinder 50, the magnetic field emanating from the cylinder 50 attracts the ferrous particles 46 of the nonmetallic base 36 and holds it against the surface of the cylinder 50 during printing. While the attraction between the ferrous particles 46 and the magnetic cylinder 50 is sufficient to hold the plate 42 in place during a printing or coating application, the relatively smaller magnitude of attraction (which is proportional to the smaller quantity of metal associated with the nonmetallic base 36) facilitates easier removal and repositioning of the plate 42 on the cylinder 50 as compared to conventional steel-backed plates.

Such ease of handling promotes more accurate plate 42 placement and greater overall efficiency. Morever, as with the broad range of adhesives accommodated by the principles of the present invention, a number of suitable, prefabricated nonmetallic bases 36 are commercially available. The wide availability of such materials further reduces manufacturing costs. Also of note, the ease of manufacture of the flexible plate 42 shown in FIGS. 2 and 3 contrasts with the labor and resource intensive techniques associated with conventional fusing of a printing surface to a prior art rubber base layer.

While the present invention has been illustrated by a description of various embodiments and while these embodiments have been described in considerable detail, it is not the intention of the applicants to restrict or in any way limit the scope of the appended claims to such detail. For instance, the nonmetallic base 36 may not incorporate any ferrous particles 46, whatsoever. Such an arrangement may be desirable where the printing cylinder is not magnetized. In such an environment, the nonmetallic base 36 could be laminated, taped, clipped or otherwise secured to the cylinder. Additionally, while a preferred embodiment may have application within the field of printing, the principles of the present invention have application in any endeavor utilizing a rotating cylinder, to include those associated with the die cutting industry.

Morever, while the invention is particularly well suited to printing techniques relating to flexography, the principles of the present invention are equally applicable to all forms of printing, to include gravure, aniline, offset and photolithography. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A printing plate for use on a cylinder, comprising:
a printing member having printing and nonprinting surfaces;
a nonmetallic base having top and bottom surfaces, wherein the bottom surface is positioned directly onto the cylinder; and
an adhesive layer juxtaposed between the printing member and the nonmetallic base such that the adhesive layer bonds the nonprinting surface of the printing member directly to the top surface of the nonmetallic base.

2. The printing plate according to claim 1, wherein the nonmetallic base includes ferrous particles.

3. The printing plate according to claim 1, wherein the nonmetallic base has magnetic particles.

4. The printing plate according to claim 1, wherein the adhesive layer includes foam characteristics.

5. The printing plate according to claim 1, wherein the adhesive layer has a thickness ranging from about 0.005 inches to about 0.04 inches.

6. The printing plate according to claim 1, wherein the printing surface has a thickness ranging from about 0.03 inches to about 0.07 inches.

7. The printing plate according to claim 1, wherein the nonmetallic base has a thickness ranging from about 0.01 inches to about 0.05 inches.

8. The printing plate according to claim 1, wherein the adhesive layer is selected from a group consisting of: tape, glue, porous adhesive, epoxy, laminate, adhesive foam and some combination thereof.

9. The printing plate according to claim 1, wherein the printing surface is constructed from a material selected from a group consisting of: a polymer, a monomer, rubber, ferrous material, a laminate and some combination thereof.

10. The printing plate according to claim 1, further comprising positioning an intermediate layer between the nonmetallic base and the printing cylinder.

11. The printing plate according to claim 1, wherein the adhesive layer is discontinuous.

12. A method for constructing a plate for printing, comprising:
adhesively adhering a printing member directly to a nonmetallic base such that an adhesive layer results between the printing surface and the nonmetallic base.

13. The method according to claim 12, further comprising incorporating ferrous particles into the nonmetallic base.

14. The method according to claim 12, further comprising incorporating magnetic particles into the nonmetallic base.

15. The method according to claim 12, further comprising incorporating foam characteristics into the adhesive layer.

16. The method according to claim 12, further comprising manufacturing the adhesive layer to have a thickness ranging from about 0.005 inches to about 0.04 inches.

17. The method according to claim 12, further comprising manufacturing the printing surface to have a thickness ranging from about 0.03 inches to about 0.07 inches.

18. The method according to claim 12, further comprising manufacturing the nonmetallic base to have a thickness ranging from about 0.01 inches to about 0.05 inches.

19. The method according to claim 12, wherein the adhesive layer is selected from a group consisting of: tape, glue, porous adhesive, epoxy, laminate, adhesive foam and some combination thereof.

20. The method according to claim 12, further comprising constructing the printing from a material selected from a group consisting of: a polymer, a monomer, rubber, ferrous material, a laminate and some combination thereof.

21. The method according to claim 12, further comprising positioning an intermediate layer between the nonmetallic base and the printing cylinder.

22. A method for printing, comprising:
attaching a plate directly to a rotatable cylinder, the plate having a printing member directly adhered to a nonmetallic base such that an adhesive layer results between the printing member and the nonmetallic base; and
printing with the plate.

23. The method according to claim 22, further comprising incorporating ferrous particles into the nonmetallic base.

24. The method according to claim 22, further comprising incorporating magnetic particles into the nonmetallic base.

25. The method according to claim 22, further comprising incorporating foam characteristics into the adhesive layer.

26. The method according to claim 12, further comprising manufacturing the adhesive layer to have a thickness ranging from about 0.005 inches to about 0.04 inches.

27. The method according to claim 22, further comprising manufacturing the printing surface to have a thickness ranging from about 0.03 inches to about 0.07 inches.

28. The method according to claim 22, further comprising manufacturing the nonmetallic base to have a thickness ranging from about 0.01 inches to about 0.05 inches.

29. The method according to claim 22, wherein the adhesive layer is selected from a group consisting of: tape, glue, porous adhesive, epoxy, laminate, adhesive foam and some combination thereof.

30. The method according to claim 22, further comprising constructing the printing from a material selected from a group consisting of: a polymer, a monomer, rubber, ferrous material, a laminate and some combination thereof.

31. The method according to claim 22, further comprising positioning an intermediate layer between the nonmetallic base and the printing cylinder.
